(19) United States
(12) Patent Application Publication
(10) Pub. No.: US 2014/0213943 A1
(43) Pub. Date: Jul. 31, 2014

(54) THERAPY VIBRATION DEVICE

(71) Applicant: Kenny A. Billman, Idaho Falls, ID (US)

(72) Inventor: Kenny A. Billman, Idaho Falls, ID (US)

(21) Appl. No.: 14/163,887

(22) Filed: Jan. 24, 2014

Related U.S. Application Data
(60) Provisional application No. 61/756,826, filed on Jan. 25, 2013.

(51) Int. Cl. A61H 1/00; A61H 23/02

(52) U.S. Cl. CPC A61H 1/005; A61H 23/02
USPC 601/66

(57) ABSTRACT

A therapy vibration device, for use in increasing blood flow, relaxing muscles and the like in patients, including a support structure, at least one vibration plate coupled to the support structure, and at least one motor coupled to the at least one vibration plate. At least one power source is coupled to the at least one motor and at least one ramp coupled to the vibration plate. At least one railing may also be coupled to the support structure. Additional embodiments include a control system, including at least one payment system, coupled to the therapy vibration device. Alternative embodiments also include an additional therapy device in vibrational communication with the at least one vibration plate.

### CROSS-REFERENCE TO RELATED APPLICATION

The present application is related to and claims priority to prior U.S. Provisional Patent Application Ser. No. 61/756,826, entitled “THERAPY VIBRATION DEVICE”, filed Jan. 25, 2013 the relevant portions of said application are incorporated herein by reference.

### BACKGROUND OF THE INVENTION

1. Technical Field

This invention relates to a therapy vibration device for applying vibrations to a patient in order to relax muscles, increase blood flow and the like.

2. Background Art

In the 1989's the Russian Space program used vibration therapy to offset bone loss in Space. NASA has continued to use vibration therapy for the astronaut program.

Dr. Clinton Rubin, Director of the Center for Biotechnology, State University of New York, is currently the main researcher on the importance of vibration therapy technology. Vibration Therapy was tested on animals such as turkeys, sheep, and rats in 2001 by Dr. Rubin. Over 220 peer reviewed scientific studies have also been done on vibration therapy.

In the medical and veterinary practices there are vibration tables which are used to provide therapy to patients. Patients may lay, stand or sit on these tables in order to receive therapy. Once the patient is on the table, the table vibrates thereby vibrating the patient. Vibrating a patient can help to increase the patient's blood flow and relax the patient's muscles.

Vibration therapy may also be used in order to help a patient accelerate faster from a stand still. Vibration therapy may help aging bones to stay healthy, arthritis, athletic capabilities, back pain, athletic performance, bleeders, blood flow for medicine, bone failure/loss, and bio-mechanical stimulation of body tissue. Vibration therapy can also be used to break up scar tissue adhesions, build bone, build muscle, calm nerves, decrease blood sugar/glucose, increase bone density, grow hair, grow hooves, improve balance, improve blood circulation, improve flexibility, improve joint health and function, improve mobility and flexibility, increase bone strength, increase cartilage thickness, increase energy, increase levels of certain hormones including Human Growth Hormone and testosterone, increase osteoblastic activity and reduce osteoclastic activity, increase muscle mass, increase joint range of motion, tighten skin, increase stability, and increase strength. Vibration therapy can be used to help with a lack of blood flow to the digital cushion, pain reduction and management, Parkinson's disease, prediabetes in Adolescents/Adults, poor circulation, obesity, osteoporosis, brittle bones, Cerebral Palsy, chronic fatigue, chronic laminitis, colic, diabetic and non-diabetic neuropathy, fibromyalgia, fracture healing, high suspensory injuries, muscle cramps, bone remodeling, rheumatism, EPM in horses, sesamoidities, founder in horses, and soreness. Vibration therapy may also compensate for a lack of exercise, help with conditioning, demand energy and burn fat, develop more spring in a patient's stride, enhance the body's healing properties, increase elasticity, exercise the patient, aid in faster healing, give a feeling of general well being, improve immune function, increase growth, increase lymph flow, increase growth factor, maintain muscle mass, improve musculoskeletal health, improve muscle coordination, and massage the patient.

Vibration therapy can be used on patients who suffer from multiple sclerosis, patients who have suffered from a stroke, patients who want to lose weight, patients training for athletic competitions, patients who need to maintain bone density because of forced inactivity, patients who have been inactive and need to regain fitness ability, patients who are rehabilitating after injury, illness and surgery and the like. Vibration therapy reduces fat, inflammation, injury, muscle soreness, pain, stress, and swelling.

Vibration therapy is also helpful for all cancers, diseases and disorders, including diabetes, osteoporosis, osteoarthritis, peripheral neuropathy, depression, incontinence, headaches and the like. Vibration therapy can help improve and/or increase hormone secretion, the chance to get pregnant, breeding, embryos, Serotonin production, Norepinephrine production, Bradykinin production, Endorphin production, IGF production, bone density and the like. Vibration therapy can help with warm up, work outs and cool downs of the body without having to run or jog. Vibration therapy can also help to improve high and low oxygen, elevated blood glucose, elevated Triglycerides, elevated blood pressure, increased abdominal fat deposition, coordination, balance, mobility, glucose metabolism, fat burning, circulation, physical function, equilibrium, wound care, metabolism, tone and posture and the like. Vibration therapy can also decrease cortisol, cellulite, toxins, metabolic waste and the like. Vibration therapy further provides cardio stimulation, stimulates nitric oxide and MMP, and the like.

In animals, vibration therapy can be used to help with stifles, hocks, under run heels, thin soles, bucked skins, lameness and the like.

Overall, vibration therapy leaves patients looking and feeling better with a greater quality of life and wellness, including improving issues with patients who are handicapped or disabled.

The problem with vibration tables currently on the market is that these tables are raised above the ground. Therefore, once patients have completed their therapy and are relaxed, they must climb off of the raised table. This can be very difficult for an animal such as a horse whose legs may not be steady once they have received therapy on the vibration table. It, also, is difficult or impossible for a patient in a wheelchair to safely disembark from the current vibration tables. Potentially climbing off of the current tables may result in further injury to the patient, be it a person or animal.

Accordingly, what is needed is a vibration table that is easy to get on and off and that prevents the patient from falling and injuring themselves.

### DISCLOSURE OF THE INVENTION

The therapy vibration device disclosed hereafter may include a support structure, at least one vibration plate coupled to the support structure and at least one motor coupled to the at least one vibration plate. At least one power source may be coupled to the at least one motor and at least one ramp may be coupled to the vibration plate.

An additional embodiment of a therapy vibration device may include a support system, at least one vibration plate coupled to the support system, and at least one vibrator coupled to the at least one vibration plate. A power source is coupled to the at least one vibrator and at least one railing coupled to the support system.

An alternate embodiment of a therapy vibration device may include an additional therapy device, at least one vibrator in vibratory communication with the additional therapy device, and a power source coupled to the at least one vibrator.

The foregoing and other features and advantages of the therapy vibration device will be apparent to those of ordinary skill in the art from the following more particular description of the invention and the accompanying drawings.

### BRIEF DESCRIPTION OF THE DRAWINGS

The invention will hereinafter be described in conjunction with the appended drawings where like designations denote like elements, and:

FIG. 1 is an isometric view of a therapy vibration device;

FIG. 2 is a left side view of a therapy vibration device;

FIG. 3 is a right side view of a therapy vibration device;

FIG. 4 is a front end view of a therapy vibration device;

FIG. 5 is a rear end view of a therapy vibration device;

FIG. 6 is a side view of a therapy vibration device partly folded

FIG. 7 is a side view of a therapy vibration device completely folded;

FIG. 8 is top view of a therapy vibration device completely folded;

FIG. 9 is a bottom view of a therapy vibration device completely folded;

FIG. 10 is an end view of a therapy vibration device completely folded;

FIG. 11 is an isometric view of a therapy vibration device with a horse on it;

FIG. 12 is an isometric view of a therapy vibration device with a wheelchair on it;

FIG. 13 is an isometric view of an alternate embodiment of a therapy vibration device;

FIG. 14 is an isometric view of a therapy vibration water device;

FIG. 15 is an isometric view of a therapy vibration device with an additional therapy device; and

FIG. 16 is a trailer configured to carry multiple therapy vibration devices.

### DESCRIPTION OF THE INVENTION

As discussed above, embodiments of the present invention relate to a therapy vibration device for providing vibration therapy to medical and veterinary patients. In particular, disclosed is a therapy vibration device which is easy to get on and off and which prevents patients from falling and injuring themselves.

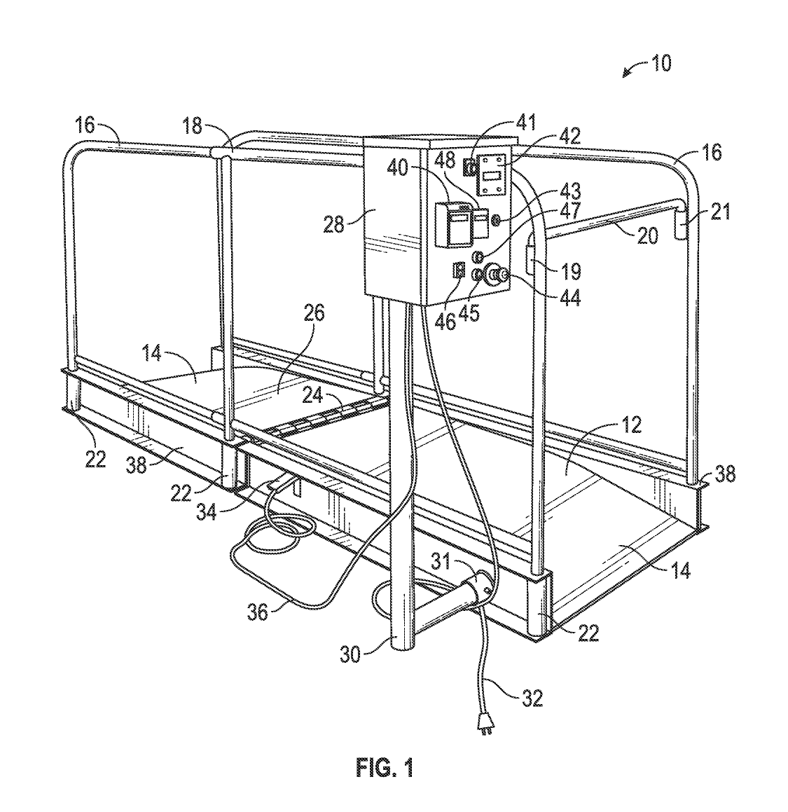

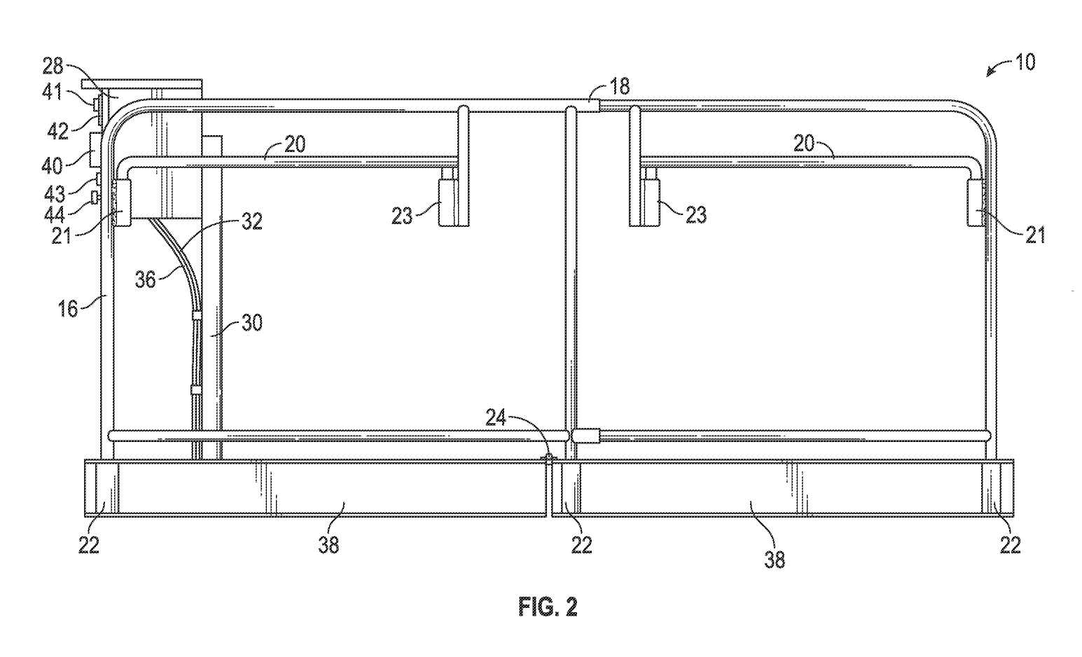

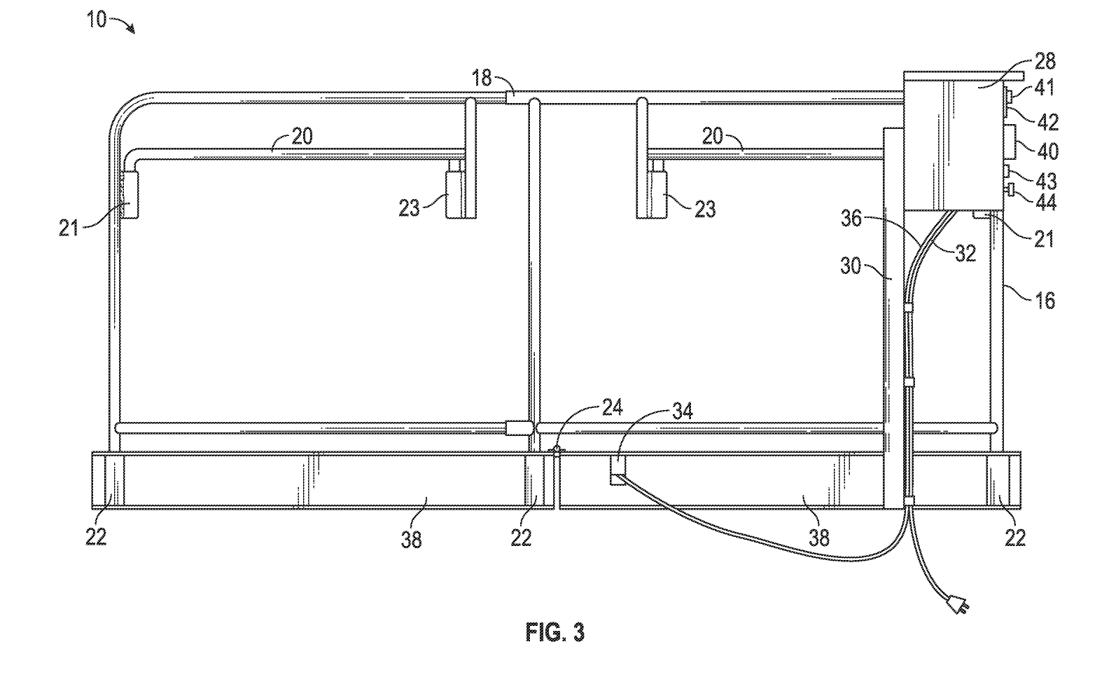

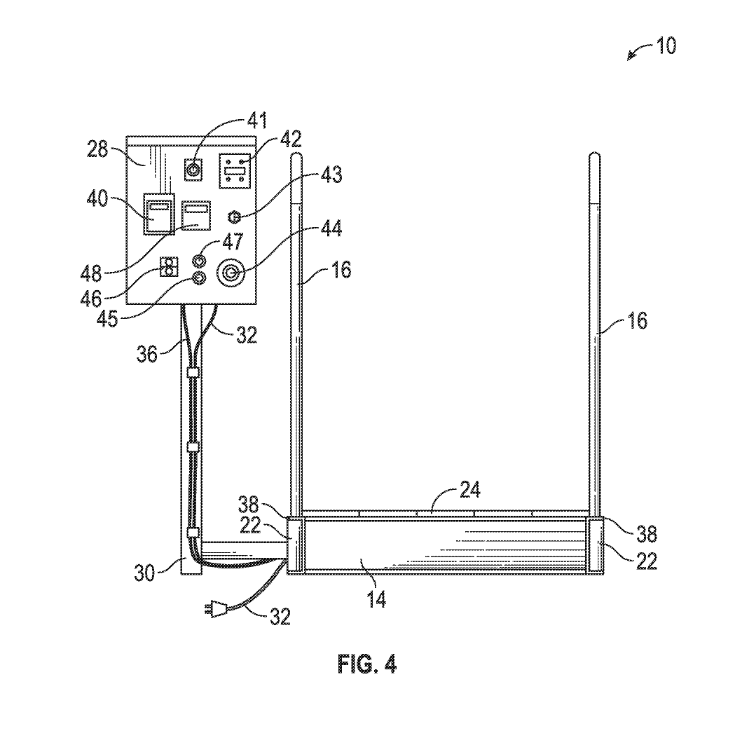

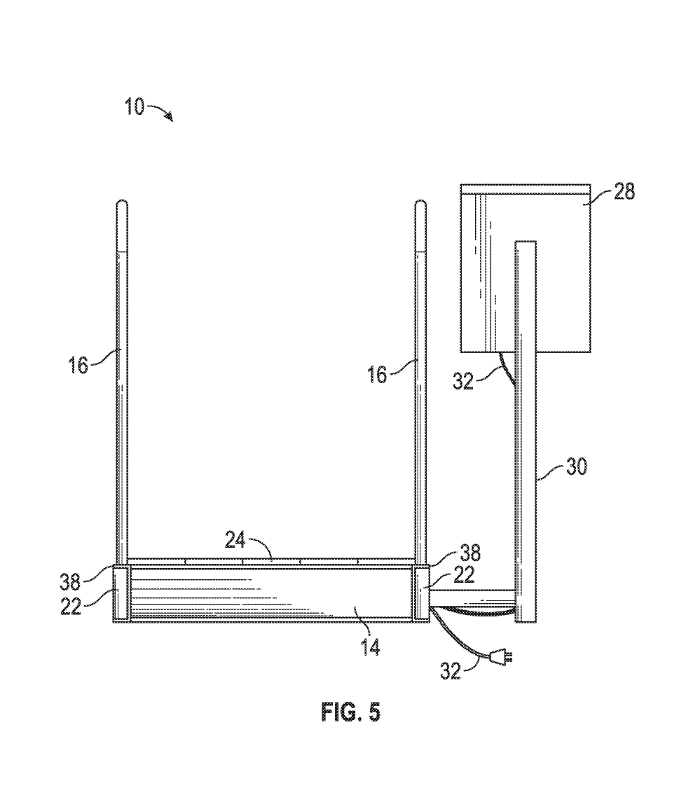

FIGS. 1-5 illustrate a therapy vibration device 10. The therapy vibration device 10, includes a vibration plate 12. The vibration plate 12 is the platform on which the patient stands, sits, walks or lays in order to receive therapy. A patient may also stand at different angles or place just a part of their body on the vibration plate 12 in order to receive therapy at a specified location on the body. The vibration plate 12, as illustrated in the figures, is a flat rectangular metallic plate which vibrates when the device 10 is turned on. The vibration plate 12, however, may be formed in any shape desirable, such as a square, circle, triangle, hexagon, pentagon and the like. The vibration plate 12 may be flat or else it may be angled, arched or the like.

The vibration plate 12 may also be formed from any material that is strong enough to support the weight of the patient and which vibrates when vibration is applied to it. It may also be desirable to form the vibration plate 12 from a lightweight material so that the device 10 may be moved easily when necessary. It may, therefore, be desirable to form the vibration plate 12 from a material such as steel, aluminum and the like.

The vibration plate 12 may be formed from one solid piece of material or the vibration plate 12 may be hinged in order to allow the plate 12 to be folded for storage. The vibration plate 12 may have one hinge or multiple hinges in order to allow the plate to fold like an accordion. The vibration plate 12 may also be pliable in order to allow the plate to be bent for storage.

In alternate embodiments, the vibration plate 12 may include multiple vibrating or treatment zones. Each of the multiple vibrating or treatment zones could be individually controlled in order to provide the patient with more individualized therapy.

At least one ramp 14 is coupled to the vibration plate 12. The at least one ramp 14 allows the patient to easily enter and exit the therapy vibration device 10. Unlike prior vibration tables, the therapy vibration device 10 disclosed herein does not require that the patient climb up onto the vibration plate 12. Instead, the patient walks up the at least one ramp 14 to enter the therapy vibration device 10. The patient may also walk down an at least one ramp 14 to exit the device 10.

The at least one ramp 14 is particularly desirable when the patient is an animal such as a horse that might stumble when exiting the therapy vibration device 10. It is common for an animal to stumble when trying to climb off of a vibration table after having vibration therapy. This is due to the fact that the animal's muscles are very relaxed. Animals may be injured by falling off of a vibration table.

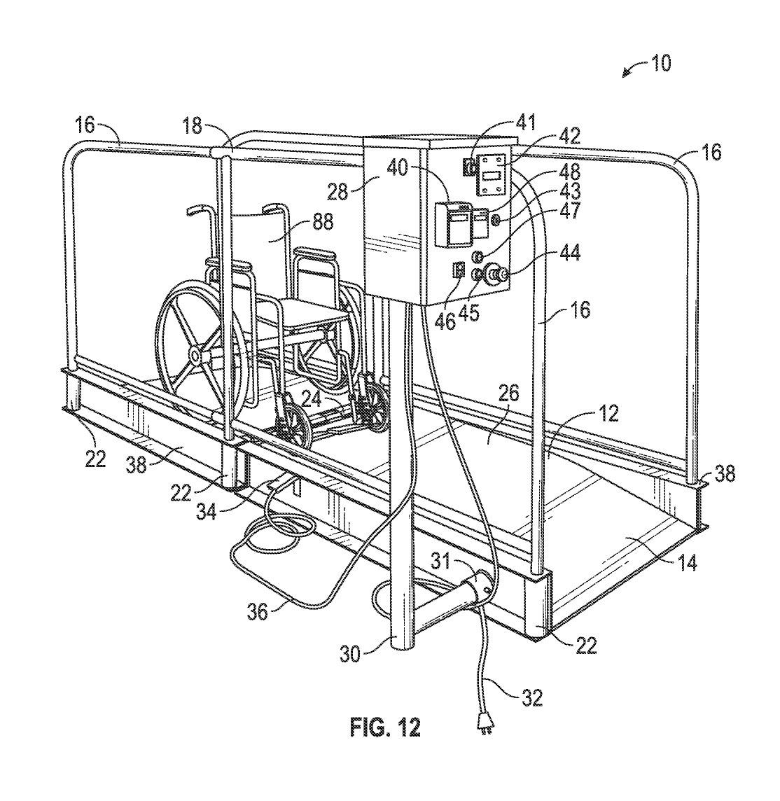

The at least one ramp 14 also allows disabled individuals, such as patients in wheelchairs 88 (see FIG. 12) to enter the device 10 easily. A patient in a wheelchair 88 simply rolls themselves or is rolled up the at least one ramp 14 onto the device 10. After the patient has received vibration therapy, the patient simply rolls off of the other side of the therapy vibration device 10. In alternate embodiments, if the vibration plate 12 is large enough, an individual in a wheelchair 88 may turn their chair around and exit on the same ramp 14 by which they entered.

FIGS. 1-5 illustrate two ramps 14 coupled to the vibration plate 12. One ramp 14 is coupled to one of the short ends of the vibration plate 12, while the other ramp 14 is coupled to the other short end of the vibration plate 12. This configuration allows users to enter the device 10 on one ramp 14 and to exit the device 10 on the other ramp 14.

In alternate embodiments, multiple ramps 14 may be positioned to surround the entire vibration plate 12 in order to allow the patient to exit the device 10 any direction desired.

In other embodiments, only one ramp 14 may be coupled to the vibration plate 12. The ramp 14 would be used by the patient to both enter and exit the device 10.

The ramps 14 illustrated in the figures are flat, rectangular plates which are approximately the same width as the vibration plate 12. The ramps 14 are coupled to each end of the vibration plate 12. The ramps 14 are configured so that one end of the ramp 14 is at the same elevation as the vibration plate 12 and the other end of the ramp 14 is flush with the floor. This allows a patient to travel up the ramp 14 without stumbling or falling. The ramps 14 may also be formed in any shape desired, such as triangular, square, circular, trapezoidal or the like. The ramps 14 may also be arched or bent.

The ramps 14 may be formed from the same material as the vibration plate 12 or else the ramps 14 may be formed from any material desired so long as the material is able to support the weight of the patient as they enter and exit the device 10. The ramps 14 may be formed from steel, aluminum, plastic, composites, ceramics or the like.

The ramps 14 may also be formed in any thickness desired. For example, instead of being formed from a flat piece of material placed on an angle, the ramps 14 may be triangular or wedge shaped. The ramps 14 could also be shaped as hemispheres or the like.

The ramps 14 may be permanently coupled to the vibration plate 12 or else the ramps 14 may be removably coupled to the vibration plate 12 or the support system. The ramps 14 may also be hingedly coupled to the vibration plate 12 in order to allow the ramps 14 to fold up for storage. The ramps 14 may also be formed as part of the vibration plate 12.

The ramps 14 may be formed from one sold piece of material, or else the ramps 14 may be formed from multiple hinged or coupled pieces of material. The ramps 14 may be formed with one hinge in order to allow the ramps to be folded in half either lengthwise or widthwise. The ramps 14 could also have multiple hinges in order to allow them to fold accordion style for storage.

The ramps 14 and the vibrating plate 12 may be covered with at least one mat 26. The at least one mat 26 may be waterproof in order to protect the ramps 14 and the vibrating plate 12 from any liquids that might be spilled on the device. In a veterinary practice it will likely be important that at least one mat 26 be waterproof in case the animal urinates on the device 10 during therapy. The at least one waterproof mat 26 may also have a lip running around the edge of the mat 26 in order to prevent any liquids poured or spilled on the mat 26 from running off of the mat 26.

Instead of a lip running around the edge of the mat 26, the at least one mat 26 may have tubing, such as thin rubber tubing, placed around the edges of the mat 26 in order to prevent liquids from running off of the mat 26 and getting on the device 10.

The mat 26 may also have a slip resistant surface in order to prevent patients from slipping when they enter or exit the device 10 or during therapy.

The mat 26 may also be removable for cleaning, or the mat 26 may be permanently coupled to the ramps 14 and the vibrating plate 12. The mat 26 may be formed by pouring a rubber or polymeric compound onto the ramps 14 and/or the vibrating plate 12. The compound once set would form a mat 26 which is permanently coupled to the ramps 14 and/or the vibrating plate 12.

The mat 26 may also be a belt that operates as a treadmill in certain embodiments.

In alternate embodiments, it may also be desirable to only have the mat 26 cover part of the device 10, i.e. just the ramps 14 or just the vibrating plate 12.

The vibration plate 12 is supported by or coupled to a support system including at least one channel beam 38 running along the edge of the vibration plate 12. In typical embodiments of the therapy vibration device 10, two channel beams 38 will be utilized. One channel beam 38 is placed adjacent to one of the long edges of the vibration plate 12. The other channel beam 38 is placed adjacent to the opposite long edge of the vibration plate 12.

The channel beams 38 are positioned so that the flat bottom of the channel runs along the edge of the vibration plate 12. The top of the channel faces away from the edge of the vibration plate 12. In this orientation, a flat plate runs along the edge of the vibration plate 12, while the two lips of the channel run along the outside of the device 10.

The channel beams 38 may be formed in any size, shape or from any material desirable. In the figures, the channel beams 38 are straight lengths of material formed with a C cross section, however, in other embodiments the channel beams 38 may be curved or bent in order to follow the edges of the vibration plate 12. For example, if the vibration plate 12 is round, the channel beams 38 would be curved in order to run adjacent the edges of the vibration plate 12.

The channel beams 38 may also be formed with any cross section desired. The channel beams 38 as illustrated in the figures are formed with a C or channel cross section. It may, however, be desirable to use beams with other cross sections, such as I or T or the like. It may also be desirable to simply use strips of sheet metal in place of the channel beams 38.

The channel beams 38 may be formed from any material desired, such as metal, plastic, composites, ceramics or the like. The channel beams 38 should also be formed from a material strong enough to aid in supporting the vibration plate 12 when a patient is on the plate.

The therapy vibration device 10 may also have at least one railing 16 running adjacent the edge of the at least one ramp 14 and the vibration plate 12. The at least one railing 16 would help to prevent patients from falling on or off the device 10. The at least one railing 16 would also help to keep veterinary patients on the device 10 during therapy.

The at least one railing 16 may also only run along the vibration plate 12 or only run along the at least one ramp 14, instead of running along both the vibration plate 12 and the at least one ramp 14.

The at least one railing 16 as illustrated in the figures is two railings 16, one that runs along each of the long sides of the vibration plate 12 and the ramps 14.

The at least one railing 16 may include or comprise at least one vertical member which supports at least one horizontal member running perpendicular to the at least one vertical member. The horizontal member may run across the top, middle or bottom of the vertical members. However, it may be desirable that the horizontal member runs across the top of the vertical members as illustrated in the figures in order to create a hand railing for use by patients as they enter, exit and use the device 10. The railing 16 may also have a horizontal member running along the bottom of the vertical members in order to help provide stability to the railing 16. An additional horizontal member may run along the middle of the vertical members to provide additional stability and a lower hand railing 16 for patients.

The railing 16 may be formed from any shape, type or size of material. The railing 16 illustrated in the figures is formed from round cross sectional tubing. The railing 16 however may be formed from material which is solid or hollow and which has a square, triangular, hexagonal, oval, trapezoidal, flat or the like, cross section. The railing 16 should, however, be formed from a material and in a shape which provides enough stability and strength to support the user should they slip or fall entering, exiting or using the device 10.

The railing 16 may be permanently or removably coupled to the device 10. If the railing 16 is removably coupled to the device 10, it may be desirable that the railing 16 be collapsible. The figures illustrate a collapsible railing 16. The railing 16 at location 18 is formed from two pieces. The material used to form the railing 16 on one side of location 18 has a smaller cross section than the material used to form the railing 16 on the other side of location 18. The larger cross sectional railing 16 material is also hollow.

When the railing 16 is removed from the device 10, the smaller cross section railing 16 material is slid inside the larger cross section railing 16 material, thereby collapsing the railing 16 into a smaller more portable configuration.

In alternate embodiments, the railing 16 may be hinged in order to fold up for storage or transportation. The railing 16 may also come apart into multiple pieces for storage or the like.

The railing 16, as illustrated in the figures, may also be removably coupled to the device 10. Each of the vertical members of the railing 16 fit into a railing receiver 22 located along the channel beams 38 of the device 10. The railing receivers 22 may be openings cut into the lips of the channel beams 38 or else the railing receivers 22 may be pipes which have a slightly larger diameter than that of the railing's 16 vertical members. The pipes are coupled to the channel beams 38 running along the edge of the vibration plate 12. The pipes may also have material forming a closure on the bottom of the pipe, in order to prevent the vertical members of the railing 16 from exiting the bottom of the railing receiver 16.

The railing receivers 22 hold the vertical members of the railing 16 when the railing 16 is in use on the device 10. When the railing 16 is not in use on the device 10, the railing 16 may be removed from the device by removing the vertical members of the railing 16 from the railing receivers 22.

Alternate embodiments of the railing 16 may be adjustable so that the height of the railing 16 may be adjusted for the specific patient using the device 10.

The railing 16 may also include at least one gate 20. The at least one gate 20 may be a section of railing material that can be positioned horizontally across the end of the two railings 16 in order to close off the entrance or exit to the device 10. The gate 20 may also be a chain, rope, cable, wire or the like which is positioned across the end of the two railing 16 in order to close off the entrance or exit of the device 10. The gate 20 may also be a railing section with multiple vertical and horizontal members which is placed across the entrance or exit of the device 10.

The device 10 may incorporate one gate 20 across either the entrance or exit of the device 10. In alternate embodiments, two gates 20 may be used, with a gate 20 across both the entrance and the exit of the device.

In still other embodiments, the gate 20 may be removable and reattachable in order to allow a user or owner of the device 10 to move the gate 20 from the entrance to the exit of the device 10 and vice versa.

The gate 20 may be formed from any material and in any shape desired. It may, however, be desirable to form the gate 20 from a lightweight material that may be easily moved in order to open the entrance or exit of the device 10.

The at least one gate 20 may be coupled to an end of the railing 16. The at least one gate 20 may be rotatably or hingedly coupled 21 to the railing 16. The at least one gate 20 hinged coupling 21 may be a gate hinge, a compliant member or, as illustrated in the figures, the hinged coupling 21 may be a hollow pipe or hollow cylindrical member with a cross section slightly larger than the material used to create the gate 20. The end of the at least one gate 20 would have a 90 degree turn, the end of which would fit into the hollow cylindrical member and would then rotate freely allowing the at least one gate 20 to swing open or closed.

The free end of the gate 20 would also have a receiver 19, coupled to the end of the other railing 16, which would hold the gate 20 in the closed position. The gate receiver 19 may be anything which would secure the gate 20 in the closed position. As illustrated, the gate receiver 19 may be a piece of hollow pipe with a cross section slightly larger than the material that the gate 20 is formed from. The free end of the gate 20 could be formed with a 90 degree turn in order to allow the free end of the gate 20 to be inserted into the hollow pipe which forms the gate receiver 19. The gate 20 could be inserted into the gate receiver 19 by placing the end of the gate 20 through the hole in the top of the gate receiver 19 or the gate receiver 19 could be formed with an opening in its side through which the gate 20 could be snapped into place.

In alternate embodiments, the gate receiver 19 could also be an eye bolt to which the gate 20 could be secured.

When the gate 20 is in the open position, the gate 20 may be secured into position with a gate retainer 23. The gate retainer 23, as illustrated in the figures, is a hollow piece of pipe having an opening in its side and which is coupled to the same railing 16 to which the hinged coupling 21 is affixed. When the gate 20 is in the open position, the gate 20 is snapped into the opening in the side of the hollow piece of pipe.

The gate retainer 23 may also be an eye bolt to which the gate 20 is coupled when the gate 20 is in the open position.

The therapy vibration device 10 also comprises, includes or incorporates a controller 28 or control system. The controller 28 turns the vibration of the device 10 on or off. It controls the speed at which the device 10 vibrates. It also controls the amount of time for which the device 10 vibrates.

More specifically, the controller 28 comprises a box which contains the electronics which control operation of the device 10. The controller 28 also comprises the electronics contained in the box. The controller 28 box may be any type of container which protects the electronics, that operate the device 10, from the elements. The controller 28 box may be formed from metal, plastic, composite or the like.

The controller 28 is supported by controller support 30 which is illustrated as a pole to which the controller 28 is coupled. The controller support 30 may, however, be any type of post, table or the like which can support the controller 28. The controller support 30 may be part of the railing 16 or it may be a protrusion that extends from the railing 16 such as a shelf or the like. The controller support 30 may also be separate from the railing 16.

The controller support 30 is coupled to the support structure of the device 10 at the controller support receiver 31. The controller support receiver 31 is an opening in the channel beam 38 which has a collar that receives the controller support 30. The controller support receiver 31 may be any device, apparatus, location or the like which allows the controller support 30 to couple to the device 10.

The controller 28 contains all of the electronics which control operation of the device 10. The controller 28 may also be configured to include a power safety GFI in order to protect the electronics contained in the controller 28.

The controller 28 includes a credit card machine 40 or payment system. The credit card machine 40 allows a user to swipe their credit card through a slot in the credit card machine 40 in order to purchase time for their patient on the device 10. The cost of time on the device 10 may be altered remotely by the credit card company at the request of the owner of the device 10.

In alternate embodiments, the credit card machine 40 may also accept cash or coins for the purchase of time on the device 10. The credit card machine 40 may also be configured to accept codes specifying charge accounts which would be billed on a monthly or quarterly system.

In additional embodiments, the device 10 may be configured to run for a set amount of time each time it is turned on. A metering device would be coupled to the device 10 and would tell the owner of the device 10 how many times the device 10 was turned on so that the owner of the device 10 could charge a user according. It may also be desirable to equip the device 10 with a metering device that keeps track of how much time the device 10 is run over a given period.

The controller 28 also contains a light 41 which informs the user that the device 10 is ready to operate. This light 41 may be any color, shape, size or the like desired. In may be desired, however, to use a green light to signal that the device 10 is ready for use.

The controller 28 may also include a timer 42. The timer 42 shows the user how much time they have left on the device 10. The timer 42 may also show the user how much time they have used on the device 10. The timer 42 may count up or down depending on the desires of the owner of the therapy vibration device 10.

The controller 28 may include a lock 43 which prevents unauthorized individuals from accessing the inside of the controller 28 box. The lock 43 prevents individuals from utilizing the device 10 without paying the owner of the device 10. The lock 43 also prevents damage to the electronics in the controller 28.

It may be desirable to have a lock 43 on the controller 28, which allows the controller 28 to be opened by authorized individuals for repairs and maintenance.

The controller 28 may further include an emergency stop button 44. The emergency stop button 44 allows the user to stop the device 10 in order to prevent injury to the patient receiving the therapy.

The controller 28 also includes a start/stop button 46. The start/stop button 46 may be one button which acts as a toggle switch, or else it may be two buttons, one for start and one for stop. The start/stop button 46 allows the user to start the device 10 when the patient is ready and to stop the device 10 at any time desired.

The controller 28 may also include a button 47 which speeds up the vibrations of the device 10. A button 45 that slows down the vibration of the device 10 may also be included. These buttons 45 and 47 allow the user to control and manipulate the speed at which the patient is being vibrated.

In alternate embodiments, the device 10 may be configured to automatically vary the speed of vibration for therapy.

The controller 28 can also include a screen 48 which provides messages to the user. Messages may include advertisements, welcomes, instructions and the like.

The controller 28 may include any alternate or additional, buttons, screens and controls desired.

The controller 28 receives power from the power source 32. The power source 32 is a plug which can be plugged into any outlet and which provides power to the controller 28.

In alternate embodiments, the power source 32 may be a battery, gas or diesel powered engine, solar cell, generator or the like. It may also be desirable to configure the device 10 so that it can utilize both 110 volt outlets and 230 volt outlets.

The controller 28 then sends power to the device 10 through power cord 36. Power cord 36 plugs into power inlet 34. Power inlet 34 may include a cover in order to prevent dirt, dust, liquids or the like from entering the power inlet 34 when the power cord 36 is not plugged in.

In order to make the therapy vibration device 10 easy to transport and store, the device 10 may be hinged so that it can be folded. As illustrated in the figures, hinge 24, which is coupled in the vibration plate 12, allows the vibration plate 12 to fold for convenience. In embodiments with hinge 24, the channel beams 38 may have a cut or separation at the location of the hinge 24 in order to allow the support structure to fold also. Once the device 10 is in the folded or collapsed position, the device may be easily moved or stored.

Hinge 24 may be any type of hinging mechanism which is sturdy enough to withstand the weight of the device. Hinge 24 may be a piano hinge, multiple hinges, a compliant member or the like. Multiple hinges 24 may also be coupled in the vibration plate 12, in order to allow the vibration plate 12 to fold accordion style.

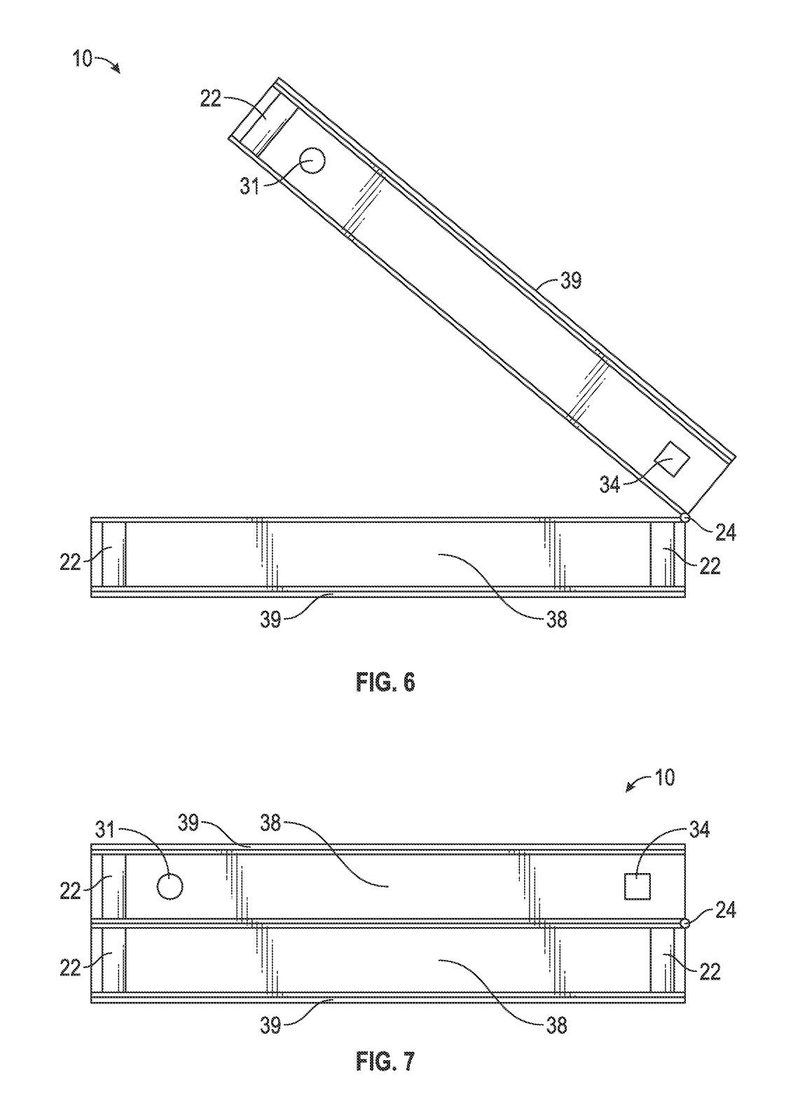

FIG. 6 shows the device 10 in the process of being folded. In order for the device 10 to fold, the railing 16 must be removed first.

FIG. 7 illustrates the device completely folded for storage or transport.

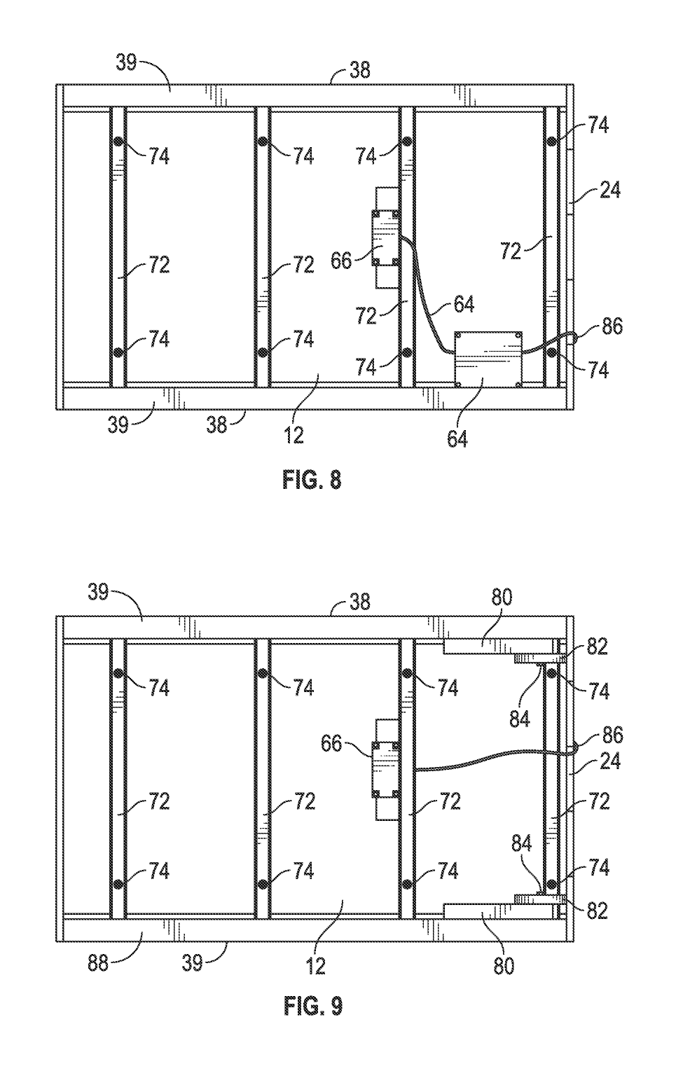

FIGS. 8 and 9 illustrate a therapy vibration device 10 in the folded position from both a top and a bottom view. When the device 10 is in the folded position, the underside of the vibration plate 12 is visible, as is the remainder of the support system.

The support system of the therapy vibration device 10 includes the at least one channel beam 38 described previously. At least one crossbeam 72 is coupled between the channel beams 38. The at least one crossbeam 72, as illustrated in the figures, is a smaller channel beam which runs perpendicular to the two channel beams 38. Typically multiple crossbeams 72 will be used in order to support the vibration plate 12.

The crossbeams 72 are channel beams which are positioned so that the lips of the channel face downward. This position provides that the flat bottom portion of the channel beam crossbeam 72 supports the vibration plate 12 positioned above it.

Each end of the crossbeams 72 is coupled to the flat side of one of the channel beams 38 that run along the edges of the vibration plate 12. The crossbeams 72 may be welded, glued, bolted, epoxied, screwed or the like to the channel beams 38.

The crossbeams 72 may be coupled to the channel beams 38 at a 90 degree angle, or else they may be positioned so that they abut the channel beams 38 at any angle desired. For example, the crossbeams 72 could be positioned so that they form a V shape, an X shape or the like.

The crossbeams 72 may be straight channel beams as illustrated in the figures or else they may be curved beams, bent beams or the like.

The crossbeams 72 may also have any cross section desired. For example, instead of a C cross section, the crossbeams 72 could have an I, T or V cross section. The crossbeams 72 may also be formed from any material desired, provided the material is strong enough to provide support to the vibration plate 12 when a patient is on it.

The crossbeams 72 are each coupled to at least one isolator 74. The at least one isolator 74 is a rubber piece which is coupled to the crossbeams 72 between the top of the crossbeam 72 (the side of the crossbeam 72 adjacent the vibration plate 12) and the vibration plate 12. Typically multiple isolators 74 will be coupled to each crossbeam 72.

The isolators 74 keep the crossbeams 72 from absorbing any or most of the vibrations applied to the vibration plate 12. The isolators 74 isolate or contain the vibration in the vibration plate 12.

The isolators 74 may be pieces of rubber, springs or the like. The isolators 74 may be coupled to the crossbeams 72 and also to the vibration plate 12, or else, the isolators 74 may simply abut the underside of the vibration plate 12. The isolators 74 may be coupled to the crossbeams 72 by bolts, screws, welding, pins, epoxy, glue and the like.

At least one motor 66, or vibrator, may be mounted to a crossbeam 72 on the underside of the vibration plate 12 or the at least one motor 66 may be mounted directly to the underside of the vibration plate 12. The at least one motor 66 abuts the vibration plate 12 or is in vibratory communication with the vibration plate 12. The at least one motor 66 when turned on causes the vibration plate 12 to vibrate, thereby vibrating the patient. The at least one motor 66 may be any vibrating motor which has enough power to vibrate the patient.

Therefore, if the patient is bigger, such as a horse or the like, the vibrating motor must be bigger in order to have enough power to vibrate the patient sufficiently.

As can be seen in both FIGS. 8 and 9, there may be at least one motor 66 on each half of the vibration plate 12. Particularly, in embodiments, where the vibration plate 12 is hinged in the middle for folding, two motors 66 will be necessary in order to provide vibration along the whole vibration plate 12.

Alternatively, in situations where large patients are being treated, multiple motors 66 may be desired in order to provide sufficient vibration to treat the patient.

The at least one motor 66 receives power from at least one power box 64. At least one power box 64 is a box which provides protection for power inlet 34. Power box 64 protects the power inlet 34 from moisture, damage, dust and the like.

Power is received from the power inlet 34 inside the power box 64 and is transmitted to the at least one motor 66 through power cord 64. Power cord 64 may be any type of power cord that can transmit enough power to operate at least one motor 66. It may also be desired that power cord 64 is a rugged outdoor cord in order to withstand the types of environments that the device 10 may be used in.

Power is also transmitted to the other at least one motor 66 through power cord 86. Power cord 86 may be any type of power cord that can transmit enough power to operate at least one motor 66. It may also be desired that power cord 86 is a rugged outdoor cord in order to withstand the types of environments that the device 10 may be used in.

The figures further depict padding 39 which is a thin rubber or other padding which runs along the bottom edge of channel beams 38 in order to protect the surfaces that the device 10 is placed on. Padding 39 also serves to help prevent the device 10 from vibrating the floor on which it is placed. Padding 39 also protects the device 10 from damage.

Padding 39 may be thin rubber padding, vinyl sheeting, felt or the like.

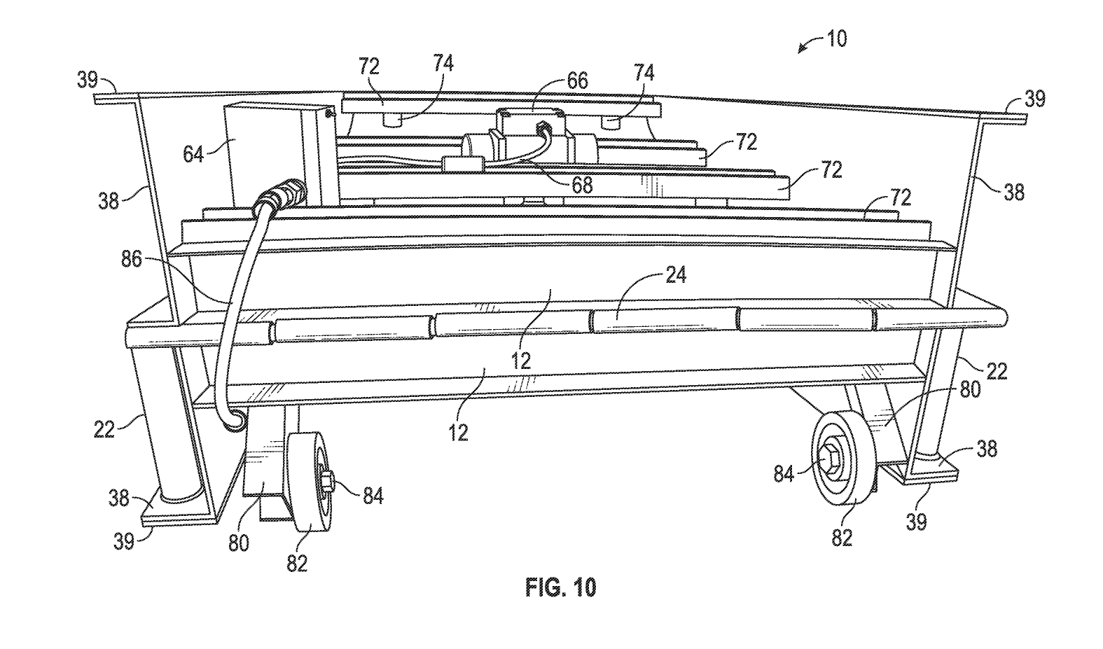

FIG. 10 illustrates the device 10 in the folded position from a direction looking at the hinge 24 in the center of the vibration plate 12.

FIGS. 9 and 10 illustrate a system of wheels 82 which allow a user to easily move the device 10 once it is folded. Wheels 82 may be any type of wheel which is strong enough to support the device 10 and small enough not to interfere with the operation of the device 10 when it is in the unfolded position.

Wheels 82 are mounted by couplers 84 to wheel braces 80. Wheel braces 80 may be coupled to crossbeam 72. Wheel braces 80 may be shaped and sized to allow the wheels 82 to extend slightly beyond the channel beams 38 when the device 10 is in the folded position. Wheel braces 80 may be formed as rectangles, triangles or the like. Wheel braces 80 may be formed from the same type of material as the cross beams or they may be formed from solid metal, plastic, ceramic, composite or the like.

Wheels 82 may be coupled to wheel braces 80 by couplers 84. Couplers 84 may be any type of coupler which allows wheels 82 to freely rotate while securing wheels 82 to wheel braces 80. Couplers 84 may be bolts, pins, shafts or the like.

In alternate embodiments, the device 10 may also include a handle that a user may utilize when moving the device 10 in the folded position.

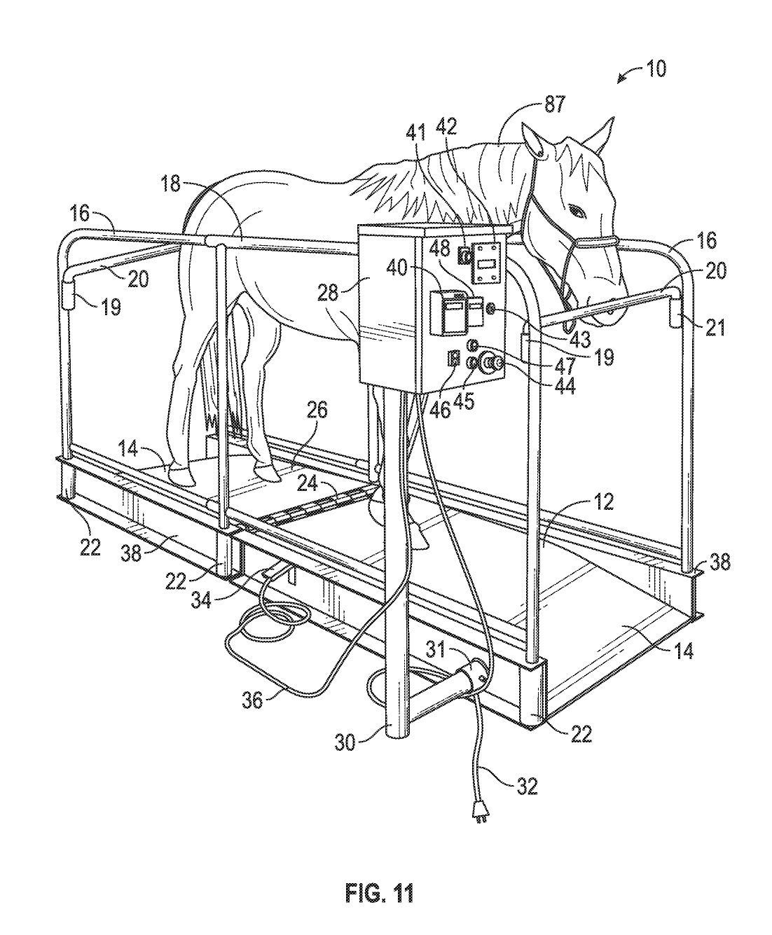

FIG. 11 illustrates a therapy vibration device 10 with a horse 87 receiving vibration therapy. The gates 20 are in the closed position in order to keep the horse 87 from leaving the device 10 during therapy. The device 10 has two ramps 14 that the horse 87 may use to enter or exit the device 10.

In alternate embodiments, the therapy vibration devices 10 may be any size or shape needed to best serve the patients. For example, a cat would need a much smaller device 10 than a horse 87 needs.

FIG. 12 illustrates a device 10 with a wheelchair 88 on it. The ramps 14 may be sized and shaped to make the device 10 fit all of the standards for the Americans with Disabilities Act. Thereby, making this device 10 wheelchair 88 accessible. Wheelchair 88 accessible devices 10 make vibration therapy available to disabled individuals who would have had a hard time climbing onto a vibration table to receive treatment.

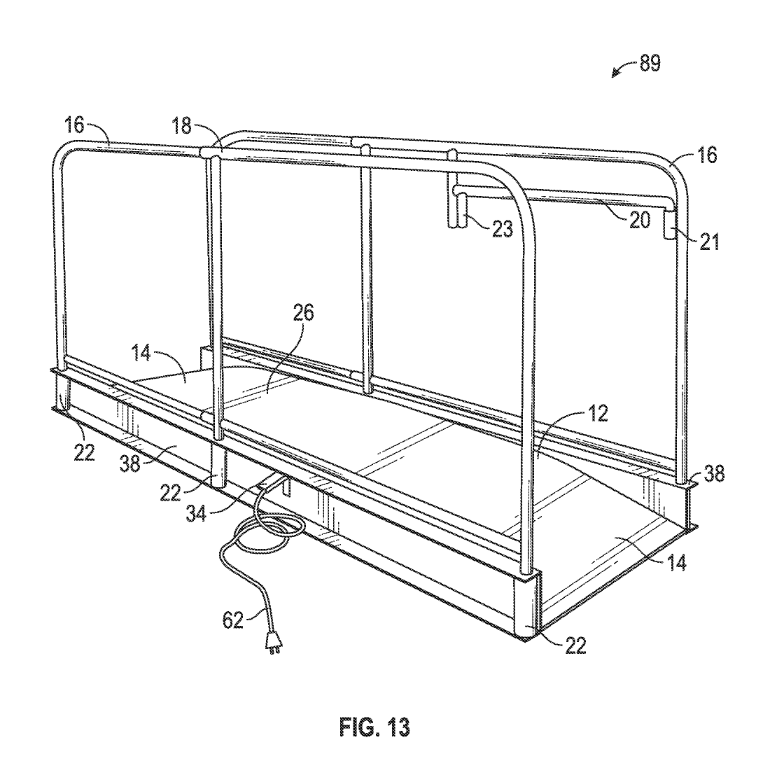

FIG. 13 illustrates an alternate embodiment of a therapy vibration device 89. This device 89 is configured for use in a hospital or other therapy location. The device 89 does not have a controller or credit card machine. Instead the device 89 runs as soon as it is plugged in with its power plug 62. This device 89 also does not have a hinge and does not fold for storage or transportation. This configuration is designed for locations where the device 89 will have a permanent location and will be used regularly.

Configurations, such as that shown in FIG. 13, may also only incorporate one motor. Only one motor is needed to treat most people. Also, without the hinge in the vibration plate, only one motor is needed to make the entire plate vibrate.

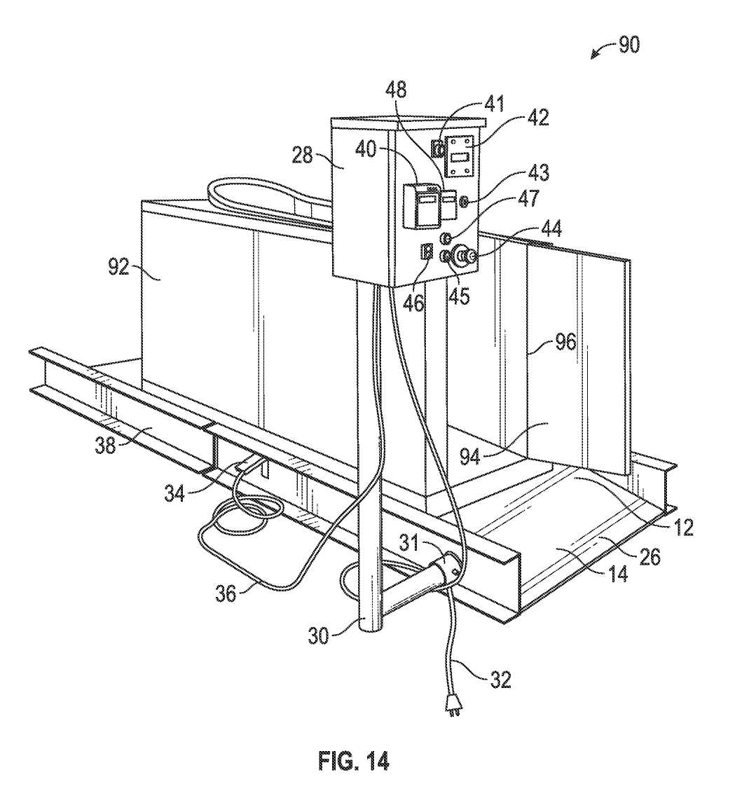

FIG. 14 illustrates an additional alternate embodiment of a therapy vibration device 90. In this figure, a walk in tub 92 is placed on top of or adjacent to the vibration plate 12. This embodiment combines water therapy and vibration therapy. In using this configuration, a patient would enter the device 90 using ramp 14. The patient would enter the tub 92 and would close tub door 94 which pivots about hinge 96, allowing patients to walk into tub 92 rather than requiring that the patient climbs into the tub 92. Once the door to the tub 92 is closed, the tub 92 may be filled with warm or cold water depending on the type of therapy which the patient is undergoing. The water may be provided by a water supply device and the temperature of the water may be controlled by a water heater or water cooling device. Time is then purchased through the credit card machine 40 and the device 90 is turned on. The vibration plate 12 vibrates, causing the tub 92 to vibrate, thereby combining vibration therapy and hydrotherapy.

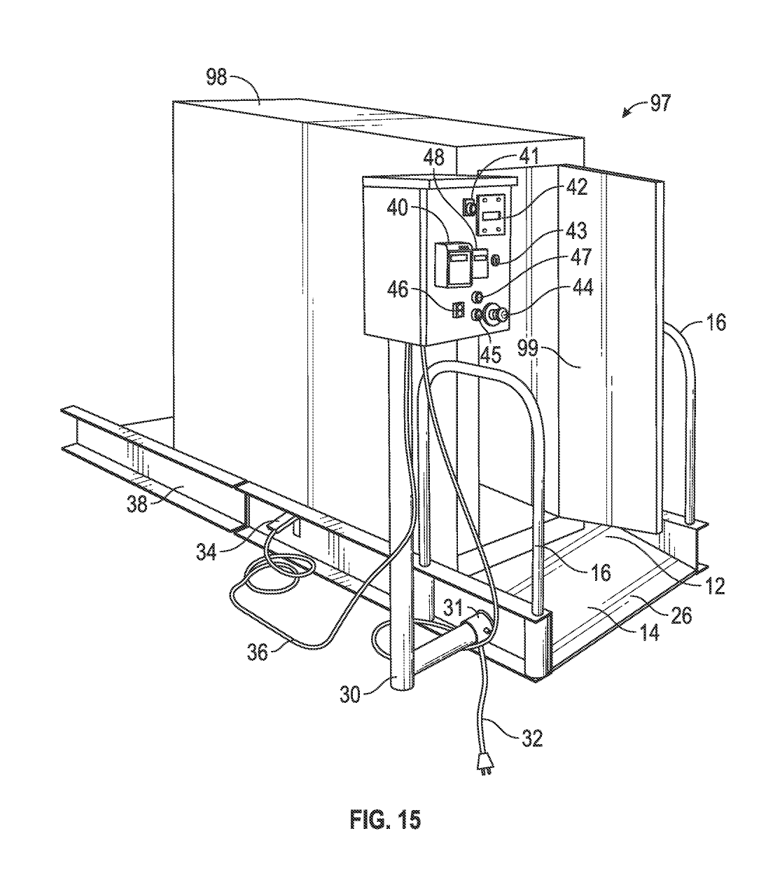

FIG. 15 illustrates more embodiments of a therapy vibration device 97. In this device 97, an additional therapy device 98 is placed on top of the vibration plate 12 of the therapy vibration device 97. The additional therapy device 98 will therefore vibrate when the therapy vibration device 97 is turned on. The additional therapy device 97 may also incorporate the vibration plate 12 as the floor of the additional therapy device 97. The additional therapy device 97 may also simply be in vibratory communication with the vibration plate 12. When an additional therapy device 97 is in vibratory communication with the vibration plate 12 or a therapy vibration device, a user using the additional therapy device 97 is receiving vibration therapy at the same time.

Additional therapy devices 98 may include a tub, a hyperbaric chamber, altitude conditioning machine, sauna, treadmill, water therapy device and the like. Altitude conditioning machines may include any device which alters conditions in order to allow a user to train or experience different elevations, oxygen levels, temperatures, pressures and the like. Additional therapy devices 98 may be enclosed and may require door 99 in order to enter the additional therapy device 98. Door 99 also serves the purpose of maintaining the atmosphere, humidity, pressure and the like within the additional therapy device 98.

Therapy vibration device 97 may also include a railing 16 in order to aid patients in entering and exiting the device 97. The railing 16 may be permanently or removably coupled to the device 97. The railing 16 may also be adjustable in order to aid different patients in entering the device 97.

In alternate embodiments of the therapy vibration device 97, a therapy vibration device 97 may be placed within an additional therapy device 98 such as a sauna, hyperbaric chamber, altitude conditioning machine and the like.

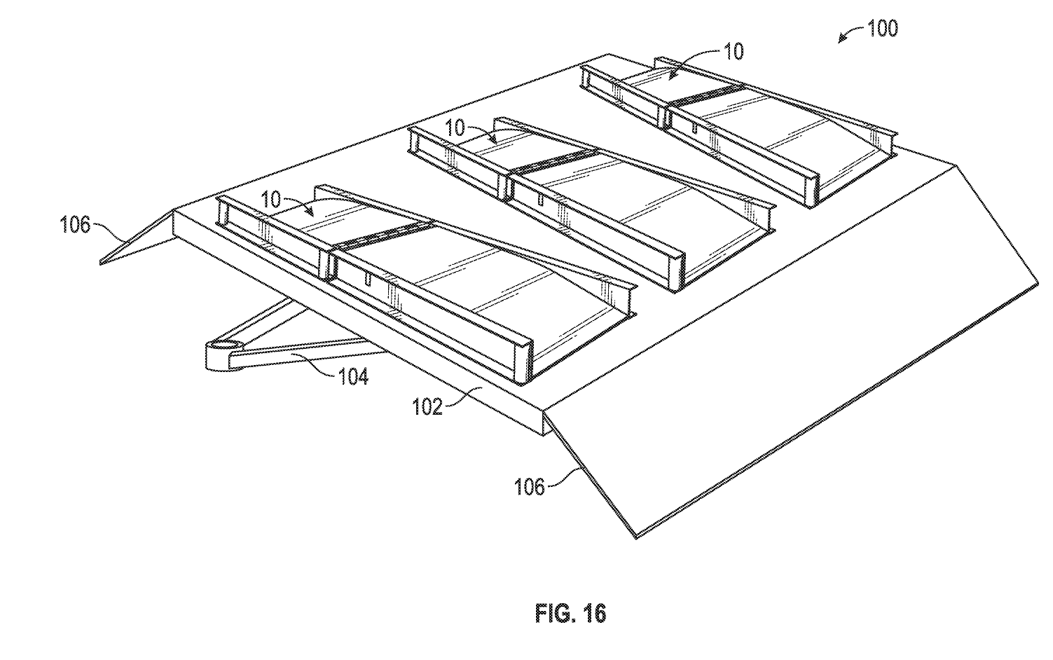

FIG. 16 illustrates yet another embodiment involving a therapy vibration device 10. This figure discloses a trailer 100 which has multiple therapy vibration devices 10 on it. In alternate embodiments, the trailer 100 may have only one therapy vibration device 10 on it. The trailer 100 may also have at least one therapy vibration device 10 on it and at least one additional therapy device in vibratory communication with the at least one therapy vibration device 10.

The trailer 100 also has a flap or ramp 106 on each side of the trailer 100. When the trailer 100 is in motion, the ramps 106 may be folded up so that they do not interfere with traveling. When the trailer 100 is stopped and patients are ready for treatment, the ramps 106 are lowered into an angled position which allows patients to easily climb up to the trailer bed 102 and onto the therapy vibration devices 10.

The trailer 100 may be enclosed or open.

The ramps 106 may also be removable and could be removed while the trailer 100 is being moved. The ramps 106 would then be reattached in order to allow patients to use the therapy vibration devices 10.

The trailer 100 is further configured to be towed 104 by any vehicle with enough power to handle the weight of the trailer 100.

In alternate embodiments of therapy vibration devices, the device may be placed in the ground so that the ramps are parallel with the ground and with the vibration plate. The patient may then walk along a flat surface in order to reach the vibration plate and receive therapy.

In additional embodiments, the device 10 may be bolted to the floor or in some other way permanently mounted in place.

Other embodiments include the therapy vibration device being placed on the ground and concrete being poured around the device in order to make the device level with the ground or in order to provide a concrete ramp on which a patient may walk to get to the vibration plate and to receive therapy. Rubber mats could then be fixedly or removably coupled to the concrete around the machine and to the concrete ramps in order to prevent slipping and protect the device from liquids.

More additional embodiments include therapy vibration devices which are configured as shoots, corrals, stalls or trailers. This may include therapy vibration devices configured as bucking shoots, strip shoots, branding shoots, panel shoots, horse trailers, flatbed trailers, enclosed trailers, animal stalls and the like. When the animals or patients enter the shoot, stall, trailer or corral, they will receive vibration therapy.

As disclosed above, certain configurations of therapy vibration devices are easily moved. This may include embodiments including water tanks or tubs and embodiments utilizing hyperbaric chambers.

Therapy vibration devices may also be configured so that the elevation or level of oxygen that the patient is experiencing can be altered.

Therapy vibration devices may be used in saunas in order to aid the body in removing toxins.

Therapy vibration devices may be combined with treadmills in order to allow a patient to combine exercise and vibration therapy by exercising on a vibrating treadmill. In embodiments of the therapy vibration device combined with a treadmill, a treadmill track may be placed around the vibration plate and/or the ramps. An additional motor may also be mounted on the device in order to power the treadmill track. However, the treadmill track may also be powered by the user running on the track. The user would then be able to run on the treadmill while receiving vibration therapy.

In additional embodiments of a therapy vibration device combined with a treadmill, the treadmill may be placed on top of the vibration therapy device.

Therapy vibration devices may also be combined with chairs in order to allow the patient to sit comfortably while receiving therapy.

Therapy water vibration devices may also be configured to wrap the user in plastic, rubber or the like, in order to keep the user dry while allowing all of the benefits of water vibration therapies.

Embodiments of therapy vibration devices may be used to increase cancer recovery, diabetic wellness, chances of pregnancy and the like. Therapy vibration devices may also be used to treat diabetes, cancer, breeding problems, other diseases, injuries and the like.

In using the device 10 disclosed in FIGS. 1-5, the owner or user of the device 10 wheels the device 10 to the desired location of use. The desired location of use may be a therapists office, a veterinary office, a doctor's office, a medical office, a hospital, an animal feed lot, an animal sale lot, a ranch, a farm, a home, a rodeo ground, an animal show, a race track, an animal exhibition and the like. The owner then opens the device 10 unfolding it in position.

Once the device 10 is unfolded and in position, the railing 16 may be inserted into railing receivers 22 located along the side of the channel beams 38. The controller support 30 may be inserted into the controller support receiver 31 and secured into position.

Once the controller 28 is in position, cord 36 may be plugged into power inlet 34. Cord 32 may then be plugged into a power outlet located in the location at which the device 10 is being used.

Now that the device 10 is in position, a patient may enter the device 10 by walking, rolling a wheelchair or the like up ramp 14 and onto the vibration plate 12. If the patient is an animal, gates 20 may be secured in the closed position.

The user may now run a credit card through the credit card machine 40 in order to purchase time for the patient on the device 10. If the patient and the user are the same, then the patient could purchase time on the credit card machine 40 prior to entering the device 10 if desired.

Once the patient is in position and the green light 41 on the controller 28 signals that the device 10 is ready, the patient or user may press the start button 46. The speed/amount of vibration that the patient is experiencing may be controlled by buttons 47 and 45 which increase or decrease the vibrating of the device 10.

When the patient has completed their therapy, the gates 20 may be opened if they were closed previously, and the patient may exit the device by going back down the ramp 14 that they entered the device 10 on or the patient may continue forward and exit the device 10 by the ramp 14 on the other side of the device 10.

Accordingly, for the exemplary purposes of this disclosure, the components defining any embodiment of the invention may be formed as one piece if it is possible for the components to still serve their function. The components may also be composed of any of many different types of materials or combinations thereof that can readily be formed into shaped objects provided that the components selected are consistent with the intended mechanical operation of the invention. For example, the components may be formed of rubbers (synthetic and/or natural), glasses, composites such as fiberglass, carbon-fiber and/or other like materials, polymers such as plastic, polycarbonate, PVC plastic, ABS plastic, polystyrene, polypropylene, acrylic, nylon, phenolic, any combination thereof, and/or other like materials, metals, such as zinc, magnesium, titanium, copper, iron, steel, stainless steel, any combination thereof, and/or other like materials, alloys, such as aluminum, and/or other like materials, any other suitable material, and/or any combination thereof.

The embodiments and examples set forth herein were presented in order to best explain the present invention and its practical applications and to thereby enable those of ordinary skill in the art to make and use the invention. However, those of ordinary skill in the art will recognize that the foregoing description and examples have been presented for the purposes of illustration and example only. The description as set forth is not intended to be exhaustive or to limit the invention to the precise form disclosed. Many modifications and variations are possible in light of the teachings above without departing from the spirit and scope of the forthcoming claims. Accordingly, any components of the present invention indicated in the drawings or herein are given as an example of possible components and not as a limitation.

1. A therapy vibration device comprising:
a support structure;
at least one vibration plate coupled to said support structure;
at least one motor coupled to said at least one vibration plate;
at least one power source coupled to said at least one motor; and
at least one ramp coupled to said vibration plate.

2. The therapy vibration device of claim 1, further comprising a control system coupled to said at least one motor, wherein said control system further comprises at least one payment system.

3. The therapy vibration device of claim 1, further comprising at least one railing coupled to said support structure.

4. The therapy vibration device of claim 1, wherein the therapy vibration device is used to increase cancer recovery, diabetic wellness, or chances of pregnancy.

5. The therapy vibration device of claim 1, wherein said at least one ramp is removably coupled to said vibration plate.

6. The therapy vibration device of claim 1, wherein said at least one vibration plate is hingedly coupled in order to allow said therapy vibration device to fold.

7. The therapy vibration device of claim 1, further comprising a additional therapy device adjacent said at least one vibration plate.

8. A therapy vibration device comprising:
a support system;
at least one vibration plate coupled to said support system;
at least one vibrator coupled to said at least one vibration plate;
a power source coupled to said at least one vibrator; and
at least one railing coupled to said support system.

9. The therapy vibration device of claim 8, further comprising a control system coupled to said at least one vibrator.

10. The therapy vibration device of claim 9, wherein said control system further comprises at least one payment system.

11. The therapy vibration device of claim 8, wherein said at least one vibration plate is hingedly coupled to allow said therapy vibration device to fold.

12. The therapy vibration device of claim 8, further comprising at least one ramp coupled to said at least one vibration plate.

13. The therapy vibration device of claim 8, further comprising an additional therapy device in vibratory communication with said at least one vibration plate.

14. A therapy vibration device comprising:
an additional therapy device;
at least one vibrator in vibratory communication with said additional therapy device; and
a power source coupled to said at least one vibrator.

15. The therapy vibration device of claim 14, further comprising at least one ramp coupled to said additional therapy device.

16. The therapy vibration device of claim 14, wherein said additional therapy device is a water therapy device.

17. The therapy vibration device of claim 14, wherein said additional therapy device is a tub, wherein said tub further comprises a water heating device or water cooling device.

18. The therapy vibration device of claim 14, wherein said additional therapy device is a treadmill.

19. The therapy vibration device of claim 14, wherein said additional therapy device is a altitude conditioning machine.

20. The therapy vibration device of claim 14, wherein said additional therapy device is a hyperbaric machine.
